(19) United States
(12) Patent Application Publication
(10) Pub. No.: US 2012/0053912 A1
(43) Pub. Date: Mar. 1, 2012

(54) METHOD FOR ESTIMATING THE HEAT EXCHANGE RATE RELATED TO EXOTHERMIC OXIDATION REACTIONS OF A DIESEL OXIDATION CATALYTIC CONVERTER IN AN INTERNAL COMBUSTION ENGINE

(75) Inventors: Francesco Cianflone, Torino (IT); Roberto Vernassa, Volpiano (To) (IT)

(73) Assignee: GM GLOBAL TECHNOLOGY OPERATIONS LLC, Detroit, MI (US)

(21) Appl. No.: 13/202,844

(22) PCT Filed: Feb. 22, 2010
(86) PCT No.: PCT/EP2010/001088

§ 371 Date: Nov. 17, 2011

(30) Foreign Application Priority Data
Feb. 24, 2009 (GB) GB0903062.8

(51) Int. Cl. G06F 17/10

(52) U.S. Cl. 703/2

(57) ABSTRACT

A method is provided for estimating the heat exchange rate related to the exothermic oxidation reactions of a catalytic converter in an internal combustion engine. Exhaust gases flow through the catalytic converter, the method includes, but is not limited to providing a thermal model of a catalytic converter where no oxidation reactions take place. The thermal model includes, but is not limited to equations that take into account the heat exchange rate related to the processes between the exhaust gases, the catalytic converter and an external environment surrounding the catalytic converter, calculating an estimated outlet temperature at the outlet of the catalytic converter, based on the thermal model, measuring an outlet temperature at the outlet of the catalytic converter comparing the estimated outlet temperature with the measured outlet temperature, thus obtaining a correction factor, correcting the thermal model by using the correction factor in order to make the estimated outlet temperature converge to the measured outlet temperature, estimating the heat exchange rate related to the exothermic oxidation reactions as the correction factor.

### CROSS-REFERENCE TO RELATED APPLICATIONS

This application is a U.S. National-Stage entry under 35 U.S.C.§371 based on International Application No. PCT/EP2010/001088, filed Feb. 22, 2010, which was published under PCT Article 21(2) and which claims priority to British Application No. 0903062.8, filed Feb. 24, 2009, which are all hereby incorporated in their entirety by reference.

### TECHNICAL FIELD

The technical field relates to the estimation of the heat release of catalytic converters placed in the exhaust manifold of internal combustion engines. More specifically, the technical field relates to a method for estimating the heat exchange rate related to exothermic oxidation reactions of a Diesel oxidation catalytic converter in a Diesel internal combustion engine.

### BACKGROUND

The catalytic converter is a device used to reduce the toxicity of emissions from an internal combustion engine; exhaust gases coming from the cylinders flow in this device placed in the exhaust manifold of an internal combustion engine. In a catalytic converter exothermic chemical reactions occur by which toxic substances like CO or HC (HydroCarbons) produced by the combustion process in an internal combustion engine are converted into less-toxic substances like CO₂ or HC oxides.

In gasoline internal combustion engines the monitoring of the catalytic converter is performed using air to fuel ratio (λ) sensors, also known as lambda sensors. The typical waveform of the signal coming from these sensors has a fundamental frequency that change significantly in case of a catalytic converter efficiency reduction. Therefore, it is possible to obtain information about the efficiency of a catalytic converter by simply monitoring the signal of the lambda sensors.

In Diesel internal combustion engines the above concept is not applicable because the injection delivery is made in a completely different manner and it is not based on the use of the information coming from a lambda sensor.

The catalytic converters operate only when they are hot. The efficiency of a catalytic converter as a function of the temperature has a profile that is initially equal to zero, then increases in a manner directly proportional to the increase of temperature until it reaches a saturation level proximate to a value of 100%. The temperature at which the efficiency is equal to 50% is called light-off temperature, and said value is for example equal to 150° C.

In current Diesel applications, two temperature sensors are installed across a Diesel oxidation catalytic converter (DOC) for monitoring the temperature of the gases flowing through said catalytic converter. The data acquired from these sensors are used to establish if the exothermic oxidation reactions are occurring as expected by an efficient converter, thus detecting whether the DOC has a low efficiency.

The two temperature sensors are placed at the inlet and at the outlet of the catalytic converter and it is possible to obtain the total heat exchange rate between the exhaust gases flowing through the catalytic converter and the catalytic converter itself by measuring said temperatures.

The total exchange heat rate is equal to the sum of the heat exchange rate related to the conventional processes between the exhaust gases, the catalytic converter and the external environment surrounding said catalytic converter, and the heat exchange rate related to the exothermic oxidation reactions occurring in the catalytic converter.

A complete model of the catalytic converter that takes into account the two above cited processes is obtained by creating a complete catalytic converter physical model.

This approach has some drawbacks because it requires a complete model of the catalytic converter, which is complex to create. Furthermore, the effectiveness of this monitoring is strongly dependent on the model errors and, at the same time, the calibration of this complex physical model is difficult to be performed.

In view of the above, it is at least one object to provide an improved method for estimating the heat exchange rate related to exothermic oxidation reactions of a Diesel catalytic converter, allowing to overcome the above-outlined inconveniences of the prior art systems. In addition, other objects, desirable features and characteristics will become apparent from the subsequent summary and detailed description, and the appended claims, taken in conjunction with the accompanying drawings and this background.

### BRIEF DESCRIPTION OF THE DRAWINGS

The present invention will hereinafter be described in conjunction with the following drawing figures, wherein like numerals denote like elements, and:

FIG. 1 is flow chart of a method for estimating the outlet temperature of a catalytic converter wherein no oxidation reactions take place;

FIG. 2 is a flow chart of a method for estimating the heat exchange rate related to the exothermic oxidation reactions according to an embodiment of the present invention;

FIG. 3 comprises two graphs showing the temperature and the oxidation heat release estimated according to the method of an embodiment of the invention; and

FIG. 4 shows a graph of the heat release of a new and an old catalytic converter.

### DETAILED DESCRIPTION

The following detailed description is merely exemplary in nature and is not intended to limit application and uses. Furthermore, there is no intention to be bound by any theory presented in the preceding background or summary or the following detailed description.

Briefly, the method according to an embodiment of the invention is based on the estimation of the heat exchange rate related to the exothermic oxidation reactions by using a partial physical model of the inert part of the catalytic converter.

The method is based on the development of a thermal model of a non-active catalytic converter. In this case no oxidation reactions take place and only the heat exchange rate related to the conventional processes between the exhaust gases, the catalytic converter and the external environment surrounding said catalytic converter have to be modeled.

Two main thermal exchange contributions are considered in this model of a non-active catalytic converter:

the thermal exchange between the exhaust gases and the catalytic converter; and the thermal exchange between the catalytic converter and the external environment.

According to an embodiment of the present invention, the structure of the model is defined by the following equations:

$$\begin{matrix}\frac{d {Q}_{in}}{d t} + \frac{d {Q}_{out}}{d t} + \frac{d {Q}_{exch 1}}{d t} = 0 & ( 1 ) \\ C \frac{d {T}_{cat}}{d t} = \frac{d {Q}_{exch}}{d t} & ( 2 )\end{matrix}$$

Where Qᵢₙ is an input entropy flow rate at the inlet of the catalytic converter, Qₒᵤₜ is an output entropy flow rate at the output of the catalytic converter, Q_{exch1} is the thermal exchange between the exhaust gases and the catalytic converter, Q_{exch} the heat exchange rate due to the conventional processes between the exhaust gases, the catalytic converter and the environment, C is a heat capacity of the catalytic converter and T_{cat} is a temperature value indicative of the thermal state of the catalytic converter; it can be seen as an average catalytic converter temperature.

The Q_{exch} term is the sum of the thermal exchange between the exhaust gases and the catalytic converter Q_{exch1} and the thermal exchange between the catalytic converter and the external environment Q_{exch2} .

Q_{exch1} is a function of an inlet gas temperature Tᵢₙ, the average catalytic converter temperature T_{cat} and an exhaust mass flow rate at the inlet of the catalytic converter \dot{m}ᵢₙ.

Q_{exch2} is a function of the average catalytic converter temperature T_{cat} and a temperature of the external environment Tₑₙᵥ. For example, the following equations are used:

Q_{exch1}=k₁\dot{m}ᵢₙ(Tᵢₙ−T_{cat}) (3)

Q_{exch2}=k₂(Tₑₙᵥ−T_{cat}) (4)

The input entropy flow rate Qᵢₙ and the output entropy flow rate Qₒᵤₜ are defined according to the following equations:

$$\begin{matrix}\frac{d {Q}_{in}}{d t} = {\dot{m}}_{in} {C}_{p} {T}_{in} & ( 5 ) \\ \frac{d {Q}_{out}}{d t} = - {\dot{m}}_{out} {C}_{p} {T}_{out} & ( 6 )\end{matrix}$$

Where \dot{m}ₒᵤₜ out is an exhaust mass flow rate at the output of the catalytic converter, Tₒᵤₜ is an outlet gas temperature and Cₚ is an exhaust gas specific heat.

The equations (2), (3), (4), (5) and (6) define a dynamic system that can be solved by using known discrete time methods. The standard equation formulation for this kind of systems is the following:

$$\{ \begin{matrix}\frac{d x}{d t} = f ( x , {u}_{1} … {u}_{n} ) \\ y = g ( x , {u}_{1} … {u}_{n} )\end{matrix} \qquad ( 7 )$$

Where x is the state variable of the system, u are the input variables and y is the output variable. According to the present invention, T_{cat} corresponds to the state variable x, the inlet gas temperature Tᵢₙ and the exhaust mass flow rate at the inlet of the catalytic converter \dot{m}ᵢₙ in correspond to the input variables u of the system 7, while the outlet gas temperature Tₒᵤₜ corresponds to the output variable y of the system 7.

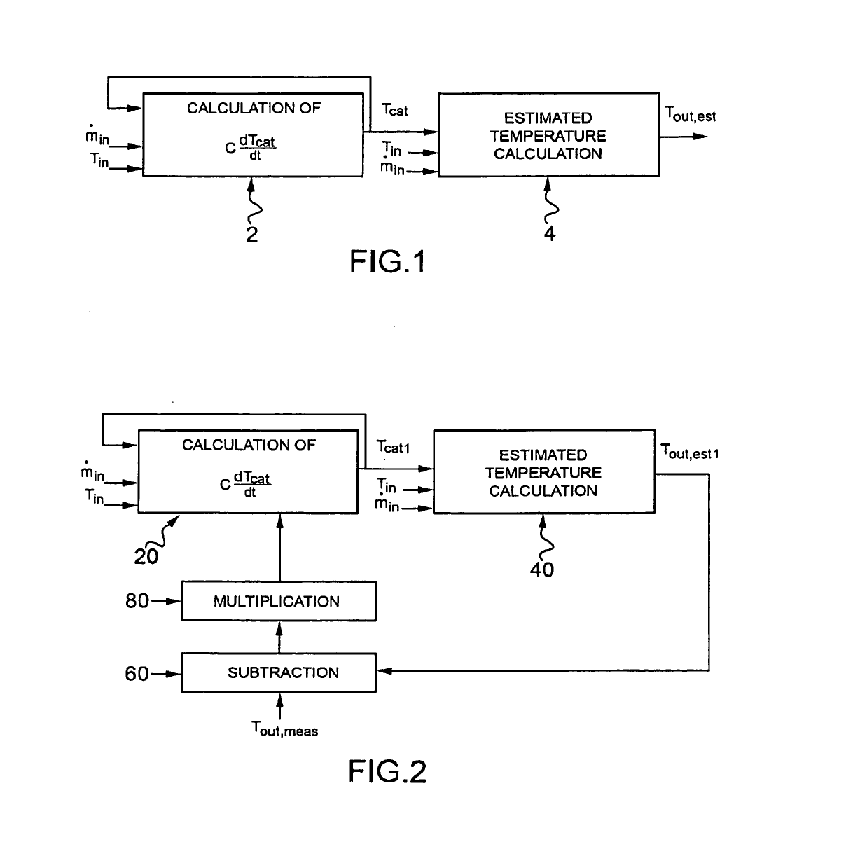

In FIG. 1 is shown a flow chart of a method for estimating the outlet temperature of a catalytic converter wherein no oxidation reactions take place. Said estimation is performed by carrying out an open loop model of a catalytic converter.

In a first step 2 a recursive calculation of an open loop average catalytic converter temperature T_{cat} is performed. In particular, it is obtained the term

$$C \frac{d {T}_{cat}}{d t}$$

at a predetermined time instant tᵢ as a predetermined function of the inlet exhaust mass flow rate \dot{m}ᵢₙ, the inlet gas temperature Tᵢₙ and the open loop temperature T_{cat} at the predetermined preceding time instant tᵢ₋₁. The output of said step 2 is the open loop temperature T_{cat} at the time instant tᵢₙ, which is in turn used in the next recursive performing of step 2.

At this point, the term

$$\frac{d {Q}_{exch 1}}{d t}$$

is obtained by means of equation (3).

At step 4 the calculation of an open loop outlet estimated temperature T_{out,est} is performed by means of equation (1). In fact, the term

$$\frac{d {Q}_{out}}{d t}$$

is obtained as the opposite of the sum of the term

$$\frac{d {Q}_{exch 1}}{d t} ,$$

obtained by means equation (3), and the term

$$\frac{d {Q}_{in}}{d t}$$

calculated by means of equation (5) where the inlet gas temperature Tᵢₙ is a value measured by means of a temperature sensor placed at the inlet of the catalytic converter. At this point, equation 6 is applied, where \dot{m}ₒᵤₜ is equal to \dot{m}ᵢₙ, thus obtaining the open loop outlet estimated temperature T_{out,est}.

The steps above disclosed perform an open loop calculation on a system comprising a catalytic converter in which no oxidation reactions occur. At this point said open loop is closed in order to compensate the error on the open loop estimated temperature T_{out,est} due to the missing contribution related to the oxidation reactions.

In FIG. 2 is shown a flow chart of a method for estimating the heat exchange rate related to the exothermic oxidation reactions according to an embodiment of the present invention.

In a first step 20 a recursive calculation of a closed loop average catalytic converter temperature T_{cat1} is performed. In this case, differently from step 2 of FIG. 1, a new term Qₒₓᵢ is considered for obtaining of the term

$$C \frac{d {T}_{cat}}{d t} ,$$

said new term Qₒₓᵢ representing the heat exchange rate related to the exothermic oxidation according to the following equation:

$$\frac{d {Q}_{oxi}}{d t} = K ( {T}_{out , meas} - {T}_{out , est} ) \qquad ( 8 )$$

Where T_{out,meas} is a value measured by means of a temperature sensor placed at the outlet of the catalytic converter.

Therefore, the following equation is obtained:

$$C \frac{d {T}_{cat}}{d t} = \frac{d {Q}_{exch}}{d t} + \frac{d {Q}_{oxi}}{d t} = \frac{d {Q}_{exch}}{d t} + K ( {T}_{out , meas} - {T}_{out , est} ) \qquad ( 9 )$$

The term

$$C \frac{d {T}_{cat}}{d t}$$

at a predetermined time instant tᵢ is obtained as the sum of the term

$$\frac{d {Q}_{oxi}}{d t}$$

and a function of the inlet exhaust mass flow rate \dot{m}ᵢₙ, the inlet gas temperature Tᵢₙ and the closed loop temperature T_{cat1} at the predetermined preceding time instant tᵢ₋₁. The output of said step 20 is the closed loop temperature T_{cat1} at the time instant tᵢ, which is in turn used in the next recursive performing of step 20.

At this point, the term

$$\frac{d {Q}_{exch 1}}{d t}$$

is obtained by means of equation (3).

At step 40 the calculation of a closed loop outlet estimated temperature T_{out,est1} is performed by means of equation (1). In fact, the term

$$\frac{d {Q}_{out}}{d t}$$

is obtained as the opposite of the sum of the term

$$\frac{d {Q}_{exch 1}}{d t} ,$$

obtained by means of equation (3), and the term

$$\frac{d {Q}_{in}}{d t}$$

calculated by means of equation (5) where the inlet gas temperature Tᵢₙ is a value measured by means of a temperature sensor placed at the inlet of the catalytic converter. At this point, equation (6) is applied thus obtaining the closed loop outlet estimated temperature T_{out,est1}.

At step 60 said closed loop estimated temperature T_{out,est1} is subtracted from the measured outlet temperature T_{out,meas} and then, at step 80 is multiplied by a predetermined proportional factor K so as to obtain the term

$$\frac{d {Q}_{oxi}}{d t}$$

which is the desired heat exchange rate related to the exothermic oxidation reactions. The term is in turn used in the step 20 thus closing the loop.

Thanks to the loop structure, the closed loop estimated temperature T_{out,est1} at each next recursive cycle converge in a progressive way to the measured temperature T_{out,meas}. This means that the term of equation (8) added to the open loop model takes into account the oxidation processes in a correct way.

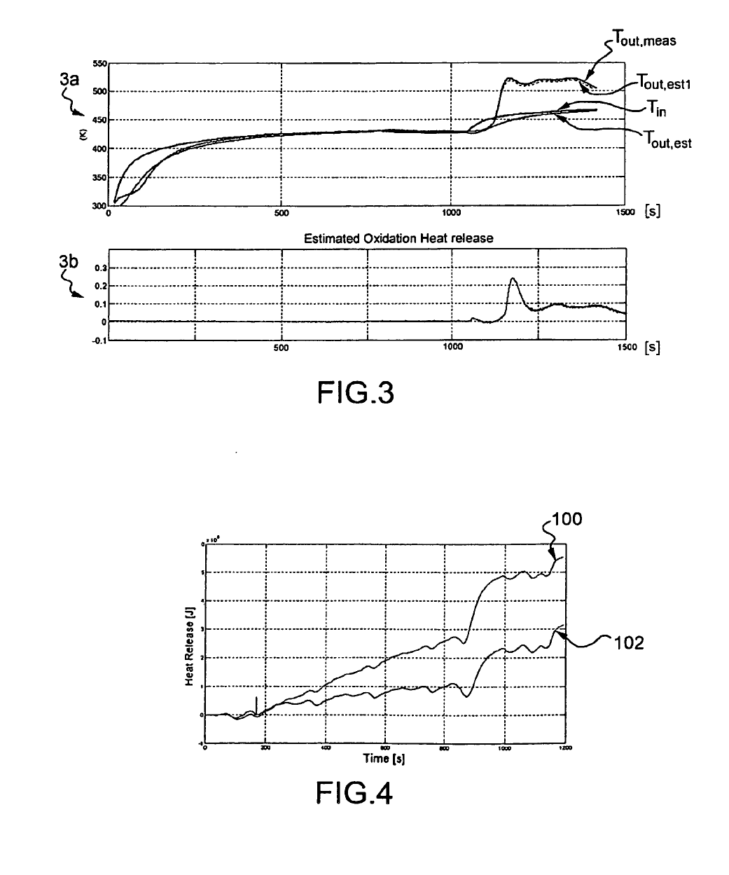

In FIG. 3 a graph 3a shows the inlet temperature Tᵢₙ, the outlet measured temperature T_{out,meas}, the open loop estimated outlet temperature T_{out,est} and the closed loop estimated outlet temperature T_{out,est1}. The monitoring of the temperatures is initiated at a predetermined time instant t₀ equal to zero. As can be noted, until the time is below to a predetermined value, for example 1000 s, in which the engine load is fixed at a predetermined value, the two temperatures are equal one each other because the catalytic converter is not operating. At a predetermined time instant, for example 1000 s, the engine load is increased and the catalytic converter begins to operate. As a result, the outlet measured temperature T_{out,meas} increases because of the exothermic reactions occurring in the catalytic converter. The open loop estimated outlet temperature T_{out,est} does not follow this variation because it does not contain the contribution due to the heat exchange rate related to the exothermic oxidation reactions while the closed loop estimated outlet temperature T_{out,est1} follows this variation because it takes account of the heat exchange rate related to the exothermic oxidation reactions.

A graph 3b shows the estimated oxidation heat release: it increases in correspondence with the increase of the outlet measured temperature T_{out,meas}.

In FIG. 4 a graph shows the heat release of a new and an old catalytic converter 100 and 102, respectively. The old catalytic converter has a lower heat release 102 because it does not correctly perform the oxidation reactions.

Clearly, the principle of the embodiments of the invention remaining the same, the embodiments and the details of production can be varied considerably from those described and illustrated purely by way of non-limiting example, without thereby departing from the scope of protection of the present invention as defined by the attached claims.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

1. A method for estimating a heat exchange rate related to the exothermic oxidation reactions of a catalytic converter in an internal combustion engine, wherein exhaust gases flow through said catalytic converter, the method comprising the steps of:
providing a thermal model of a catalytic converter, wherein no oxidation reactions take place, said thermal model comprising a plurality of equations that take into account the heat exchange rate related to the processes between the exhaust gases, the catalytic converter and an external environment surrounding said catalytic converter;
calculating an estimated outlet temperature (T_{out,est}; T_{out,est1}) at the outlet of said catalytic converter, based on said thermal model;
measuring an outlet temperature (T_{out,meas}) at the outlet of said catalytic converter;
comparing said estimated outlet temperature with the measured outlet temperature (T_{out,meas}), thus obtaining a correction factor;
correcting the thermal model by using said correction factor in order to make the estimated outlet temperature (T_{out,est}; T_{out,est1}) converge to the measured outlet temperature (T_{out,meas}); and
estimating the heat exchange rate related to the exothermic oxidation reactions as said correction factor.

2. The method according to claim 1, wherein the thermal model is based on the following equations:
$$\frac{d {Q}_{in}}{d t} + \frac{d {Q}_{out}}{d t} + \frac{d {Q}_{exch 1}}{d t} = 0$$
$$C \frac{d {T}_{cat}}{d t} = \frac{d {Q}_{exch}}{d t}$$
where Qᵢₙ is an input entropy flow rate at the inlet of the catalytic converter, Qₒᵤₜ is an output entropy flow rate at the output of the catalytic converter, Q_{exch1} is a thermal exchange between the exhaust gases and the catalytic converter, Q_{exch} is a heat exchange rate due to the processes between the exhaust gases, the catalytic converter and the external environment, C is a heat capacity of the catalytic converter and T_{cat} is a temperature value indicative of the thermal state of the catalytic converter.

3. The method according to claim 2, wherein the input entropy flow rate (Qᵢₙ) and the output entropy flow rate (Qₒᵤₜ) are defined according to the following equations:
$$\frac{d {Q}_{in}}{d t} = {\dot{m}}_{in} {C}_{p} {T}_{in}$$
$$\frac{d {Q}_{out}}{d t} = - {\dot{m}}_{out} {C}_{p} {T}_{out}$$
where \dot{m}ₒᵤₜ is an exhaust mass flow rate at the output of the catalytic converter, Tₒᵤₜ is an outlet gas temperature and Cₚ is an exhaust gas specific heat.

4. The method according to claim 3, wherein said estimated temperature is a function of an inlet exhaust mass flow rate (\dot{m}ᵢₙ) an inlet gas temperature (Tᵢₙ), the exhaust gas specific heat (Cₚ), the thermal exchange between the exhaust gases and the catalytic converter (Q_{exch1}) and the temperature value indicative of the thermal state of the catalytic converter (T_{cat}).

5. The method according to claim 1, wherein said correction factor is based on the following equation:
$$\frac{d {Q}_{oxi}}{d t} = K ( {T}_{out , meas} - {T}_{out , est} )$$
where Qₒₓᵢ is the heat exchange rate related to the exothermic oxidation.
